(19) United States
(12) Patent Application Publication
(10) Pub. No.: US 2021/0379770 A1
(43) Pub. Date: Dec. 9, 2021

(54) ATTACHMENT SYSTEM FOR ROBOTICS AND POWER TOOLS

(71) Applicant: Christian Academy of Knoxville, Knoxville, TN (US)

(72) Inventors: Abram Oaks, Knoxville, TN (US); Abigail McChesney, Knoxville, TN (US); Ethan Gibson, Knoxville, TN (US); Will Wright, Knoxville, TN (US); Seth Stalcup, Knoxville, TN (US); Aiden Stalcup, Knoxville, TN (US); Cypress Eisenmann, Knoxville, TN (US); Harrison Phillips, Knoxville, TN (US); Joshua Haley, Knoxville, TN (US); Weston Koontz, Knoxville, TN (US); B. Timothy Rhyne, Knoxville, TN (US)

(73) Assignee: Christian Academy of Knoxville, Knoxville, TN (US)

(21) Appl. No.: 16/896,476

(22) Filed: Jun. 9, 2020

(51) Int. Cl. B25J 15/04; B25J 9/12; B25J 19/00; B25J 5/00; B25J 13/00; B25J 11/00

(52) U.S. Cl. CPC B25J 15/045; B25J 9/12; B25J 19/0025; B25J 19/005; B25J 13/006; B25J 11/0055; B25J 11/0065; B25J 5/007

(57) ABSTRACT

A reconfigurable power tool is disclosed, including a tool frame, a motor attached to the tool frame, and a rotatable drive shaft attached to, and driven by, the motor. A tool attachment is configured to be removably attached to the drive shaft and is powered by rotation of the drive shaft. The drive shaft and the tool each include a coupler having a channel and rib surface. The tool attachment is removable attached to the drive shaft by slidably interlocking the channel and rib surface of the drive shaft coupler with the channel and rib surface of the tool attachment coupler in a direction substantially perpendicular to an axis of rotation of the drive shaft. A robotic device utilizing a similar tool attachment system is also disclosed.

### FIELD

This disclosure relates to reconfigurable tool attachment systems. More particularly, this disclosure relates to a tool attachment system suitable for use with robotic devices or power tools.

### BACKGROUND

Power tools find numerous applications through the manufacturing and construction industries, as well as in residential applications. In different situations, tools may be powered electrically or by use of fossil fuels. In either instance, it is often desirable to provide a power tool which may accept and utilize a variety of differing tool attachments, so as to improve the overall versatility of a single power tool system.

Likewise, both autonomous and remotely controlled robots find increasing usage in numerous industries, particularly when it is desired to limit human exposure to hazardous conditions. Here, too, it is it is often desirable to provide a robotic device which may accept and utilize a variety of differing tool attachments.

Certain tool attachment systems are known. In many instances, however, the tool attachments are either slow and cumbersome to interchange.

Thus, it would be desirable to provide a new tool attachment system for power tools and/or robotic devices which is suitable for the rapid interchanging of various tool attachments.

### SUMMARY OF THE INVENTION

The above and other needs are met by a tool attachment system according to the present disclosure. The attachments may for instance be used with a robotic device or with a power tool.

Thus, in one aspect, the present disclosure provides a robotic device. According to one embodiment, this robotic device includes a robot frame, a first motor attached to the robot frame, and a rotatable drive shaft attached to, and driven by, the motor. A tool attachment which is configured to be removably attached to the drive shaft and which is powered by rotation of the drive shaft is also included. Further, an electronic control unit is included for controlling operation of the motor. According to the present disclosure, the drive shaft and the tool attachment each comprise a coupler having a channel and rib surface. The tool attachment is removable and is attached to the drive shaft by slidably interlocking the channel and rib surface of the drive shaft coupler with the channel and rib surface of the tool coupler in a direction substantially perpendicular to an axis of rotation of the drive shaft.

According to certain embodiments, the motor is preferably an electric motor, and the robotic device also includes an electrical energy storage device for powering the electric motor.

In other embodiments, however, the motor is preferably an internal combustion engine, and the robotic device further comprises a fuel storage tank in flow communication with the engine.

In some instances, the tool attachment is preferably selected from the group consisting of a lift arm, a swing arm, a claw, a spreader, a ram, a cutter, and an elevator lift.

In some embodiments, the robotic device also preferably includes a locking mechanism for retaining the drive shaft coupler and the tool attachment coupler in connection and alignment with one another. For instance, the locking mechanism may be selected from the group consisting of a clamp, a sleeve extending over the drive shaft coupler and the tool attachment coupler, and a fastener extending through a plurality of holes formed in the drive shaft coupler and the tool attachment coupler.

In certain embodiments, the robotic device may also include a first alignment guide attached to the robot body and a second alignment guide attached to the tool attachment. These first and second alignment guides preferably slidably interlock in a direction substantially perpendicular to the axis of rotation of the drive shaft.

In accordance with certain embodiments, this robotic device preferably also includes a plurality of wheels rotatably attached to the robot frame for propelling the frame from a first location to a second location. More preferably, the robotic device further includes a second motor for driving the plurality of wheels to propel the robot.

Further, in some instances, the control unit preferably includes a radio receiver for receiving control information from an external device.

In a second aspect, the present disclosure provides a reconfigurable power tool. According to one embodiment, the power tool includes a tool frame, a motor attached to the tool frame, and a rotatable drive shaft attached to, and driven by, the motor. The power tool also includes a tool attachment which is configured to be removably attached to the drive shaft and which is powered by rotation of the drive shaft. According to the present disclosure, the drive shaft and the tool attachment each include a coupler having a channel and rib surface. Further, the tool attachment is removable and is attached to the drive shaft by slidably interlocking the channel and rib surface of the drive shaft coupler with the channel and rib surface of the tool attachment coupler in a direction substantially perpendicular to an axis of rotation of the drive shaft.

According to some embodiments, the motor is preferably an electric motor, and the power tool also includes an electrical energy storage device for powering the electric motor.

In other instances, the motor is preferably an internal combustion engine, and the power tool also includes a fuel storage tank in flow communication with the engine.

In some embodiments, the tool attachment is preferably selected from the group consisting of a drill, an angle drill, a hammer drive, a rotary hammer, a grinder, a rotary saw, a reciprocating saw, and a torque wrench.

According to some embodiments, the power tool also includes a locking mechanism for retaining the drive shaft coupler and the tool attachment coupler in connection and alignment with one another. For instance, the locking mechanism may be selected from the group consisting of a clamp, a sleeve extending over the drive shaft coupler and the tool attachment coupler, and a fastener extending through a plurality of holes formed in the drive shaft coupler and the tool attachment coupler.

In some instances, the power tool also preferably includes a first alignment guide attached to the tool frame and a second alignment guide attached to the tool attachment. These the first and second alignment guides slidably interlock in a direction substantially perpendicular to the axis of rotation of the drive shaft.

### BRIEF DESCRIPTION OF THE DRAWINGS

Further advantages of the disclosure are apparent by reference to the detailed description when considered in conjunction with the figures, which are not to scale so as to more clearly show the details, wherein like reference numbers indicate like elements throughout the several views, and wherein:

FIG. 1 is a side perspective view of a robotic device in accordance with one embodiment of the present disclosure;

FIGS. 2 & 3 are a front perspective views of a robotic device in accordance with one embodiment of the present disclosure;

FIG. 4 is a perspective view of a tool attachment for a robotic device in accordance with one embodiment of the present disclosure;

FIGS. 5a-5d are a series of side views of differing couplers for a robotic device in accordance with one embodiment of the present disclosure; and

FIG. 6 is a perspective view of a power tool in accordance with one embodiment of the present disclosure.

### DETAILED DESCRIPTION

The present disclosure provides a new tool attachment system which facilitates rapid, yet secure, attachment and detachment of tool attachments. The tool attachment system may for instance be used with either an autonomous or a remotely controlled robotic device, thereby allowing the device to utilize a variety of different tool attachments.

In other instances, the tool attachment system may be utilized for a power tool which is adapted to receive and utilizer multiple tool attachments.

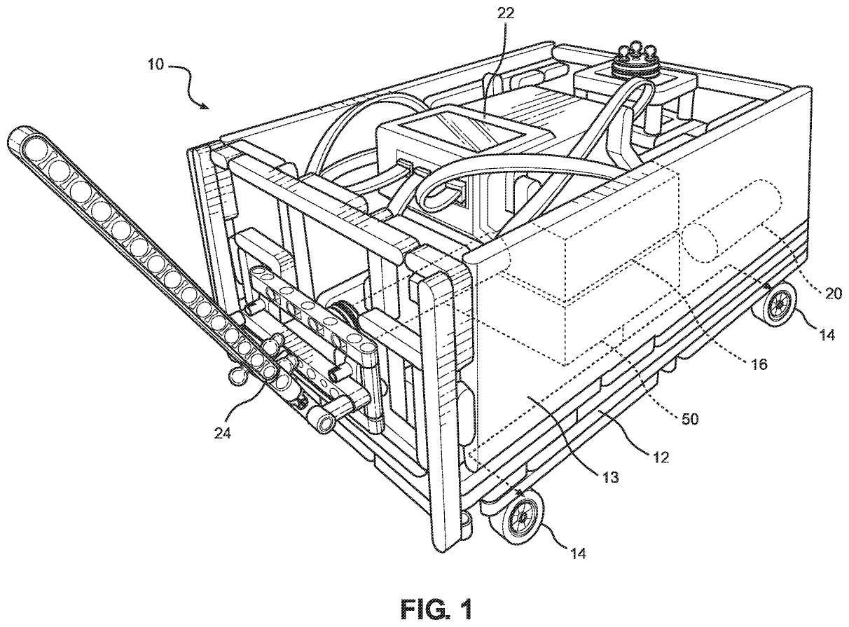

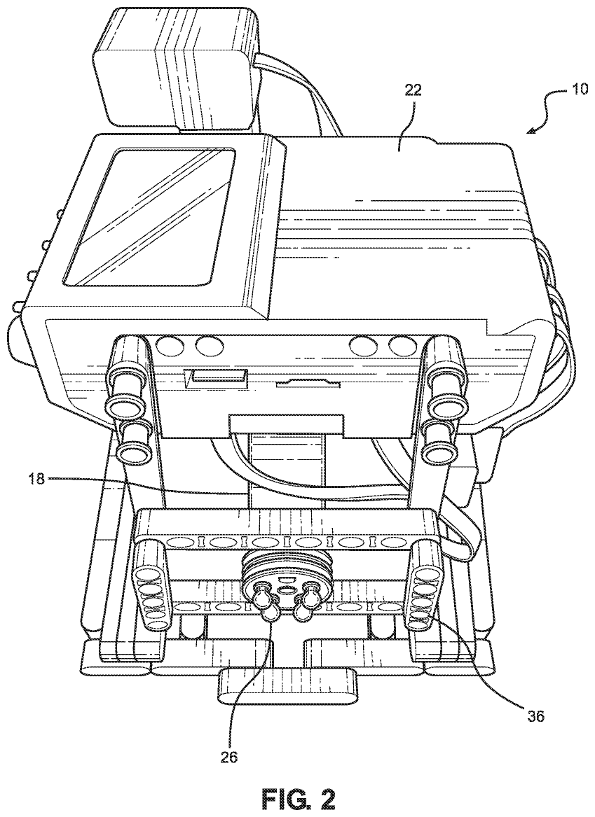

Thus, in one embodiment, the present disclosure provides a robotic device. As shown in FIGS. 1-3, the robotic device 10 includes an underlying frame or chassis 12. Typically, the robotic device also includes an exterior housing 13 which provides the general shape of the robotic device 10. In some instances, the frame 12 and housing 13 are provided as separate structural elements, so that the housing 13 may be removed from the frame 12. In other instances, the frame 12 and the housing 13 may be provided as a unitary structure. Additional components of the robotic device 10 may attached to the frame 12 and/or disposed within the housing 13.

The frame 12 and housing 13 for the device 10 may be fabricated any material of suitable strength such as metals, plastics, or wood. In instances wherein light weight is of importance, the frame 12 and/or housing 13 may preferably be fabricated from a polymeric plastic material. In other instances where additional strength and/or resistance to harsh environmental conditions is needed, the frame 12 and/or housing 13 may preferably be fabricated from a metal such as stainless steel.

In some embodiments, the robotic device 10 may be a stationary device, such as used in an assembly line, i.e., not capable of propulsion from one location to another. More typically, however, the robotic device 10 also includes a plurality of wheels 14 for movement, i.e., for propelling the frame 12 from a from a first location to a second location. In some instances, the wheels 14 may themselves be used as a part of a track assembly. The plurality of wheels 14 are generally attached to a lower portion of the frame 12 so that the frame 12 is suspended above the ground. At least a portion of the wheels 14 are driven by one or more motors which are in turn attached to the robot frame 12.

At least a first motor 16 is also included as a part of the robotic device 10. The first motor 16 is attached to the robot frame 12. A rotatable drive shaft 18 is also included which is attached to, and driven, by the first motor 16. A tool attachment may removably attached to the drive shaft 18 and powered by rotation of the drive shaft 18 as described in more detail below.

An energy storage device 20 is also for powering the first motor 16. In many instances, the first motor 16 is preferably an electric motor. In such case, the robotic device 10 also includes an electrical energy storage device, such as one or more batteries or capacitors, for powering the electric motor. In other instances, the motor alternatively be a preferably an internal combustion engine. In such cases, the robotic device 10 will then also include a fuel storage tank in flow communication with the engine.

The robotic device 10 also includes an electronic control unit 22 for controlling operation of the motor 16. Typically, this control unit 22 will include a central processing unit (CPU) as well as a memory storage unit, such as a hard drive or solid-state drive, associated with the CPU. A computer program may be uploaded to the control unit, via either a wired connection such as USB, or via a wireless connection such as Bluetooth. In some instances, the uploaded program may be sufficient to allow the robot to operate autonomously once the program is started. In other instances, the control unit 22 may also include a radio receiver for receiving further control information from an external device.

Again, the robotic device 10 includes at least a first motor 16, which powers the removable tool attachment 24 via the drive shaft 18. In some instances, this same motor 16 may also be coupled to one or more of the wheels 14 so as to provide propulsion for the robotic device 10. Preferably, however, the robotic device 10 will also include at least a second motor 50 which is coupled to the drive wheels 14 for propulsion. Thus, in such embodiments, it is not necessary for the first motor 16 to provide propulsion for the robotic device 10.

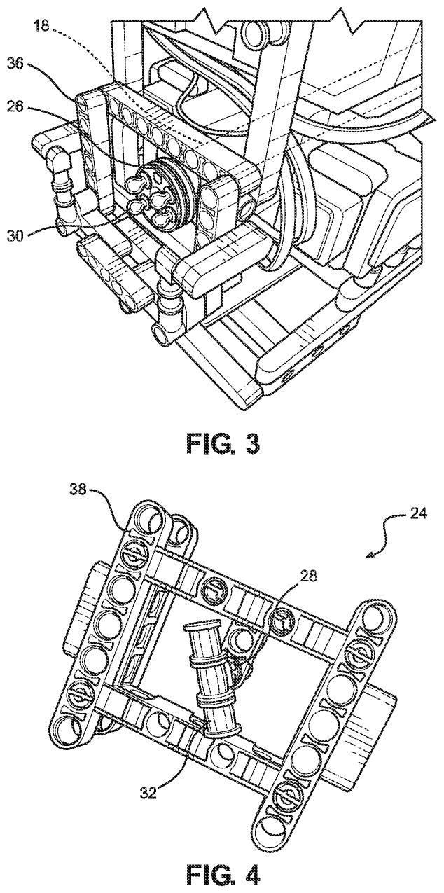

Importantly, according to the present disclosure, the drive shaft 18 and the tool attachment 24 each comprise a coupler 26, 28 having a channel and rib surface 30, 32, as shown in FIGS. 3 and 4. With these two couplers 26, 28, the tool attachment 24 may be removable attached to, and later detached from, the drive shaft 18 by slidably interlocking the channel and rib surface 30 of the drive shaft coupler 26 with the channel and rib surface 32 of the tool attachment coupler 28 in a direction substantially perpendicular to the axis of rotation of the drive shaft 18—rather than in a direction parallel to the axis of rotation of the drive shaft 18. The present inventors have advantageously found that a quick and secure alignment between the drive shaft 18 and the tool attachment 24 may be achieved in this manner.

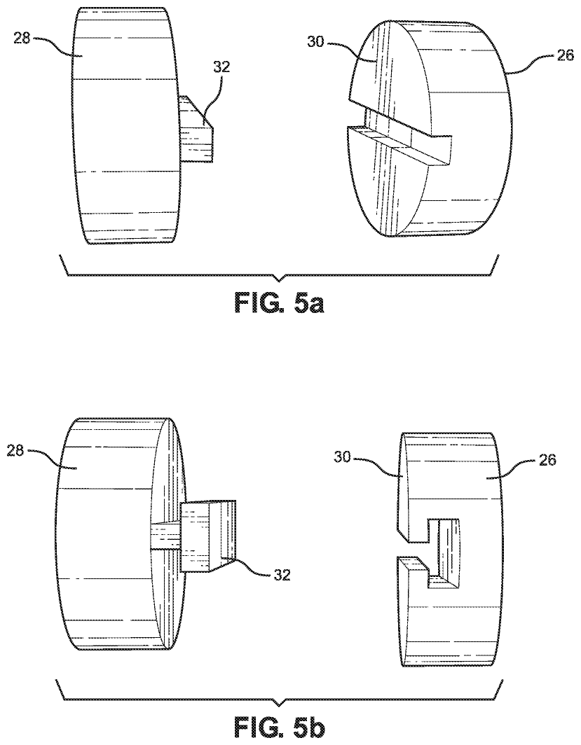

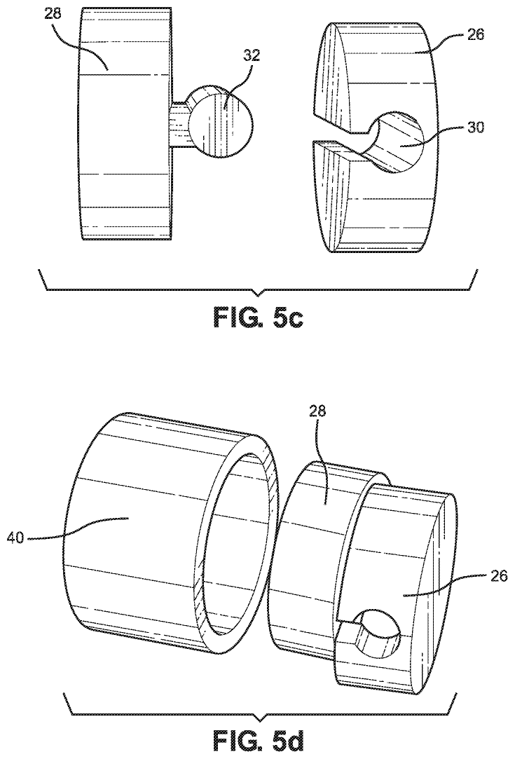

The exact shape of the channel and rib surfaces 30, 32 may vary somewhat in differing embodiments of the invention. For instance, in one embodiment, the channel and rib surfaces may be provided in a simple rectangular configuration as shown in FIG. 5a. In a second embodiment, a “T”-shaped rib may be provided, with a correspondingly shaped channel, as shown in FIG. 5b. This configuration has been found to provide improved axial connectivity between the drive shaft coupler 26 and the tool attachment coupler 28. In still another embodiment, the rib may be provided as an “O”-shaped structure, with a correspondingly shaped channel, as shown in FIG. 5c. Here too, this configuration has been found to provide improved axial connectivity between the drive shaft coupler 26 and the tool attachment coupler 28.

Moreover, in some embodiments of the present disclosure, the robotic device 10 may also include a first alignment guide 36 attached to the robot frame 12 and a second alignment guide 38 attached to the tool attachment 24. These first and second alignment guides 36, 38 preferably slidably interlock in a direction substantially perpendicular to the axis of rotation of the drive shaft 18.

In some instances, the tool attachment 24 may be sufficiently secured to the drive shaft 18 by just the interlocking of the respective channel and rib surfaces of the drive shaft coupler 26 and of the tool attachment coupler 28. In other instances, however, a locking mechanism is also used to further secure the tool attachments 24. The locking mechanism retains the drive shaft coupler and the tool attachment coupler in connection and alignment with one another. In one embodiment, the locking mechanism may for instance be a clamp, while in another embodiment, the locking mechanism may be provided by a retractable sleeve 40 which extends over the drive shaft coupler and the tool attachment coupler, as shown in FIG. 5d. In still another embodiment, a fastener such as a pin or screw may be used to further secure the tool attachment 24. The fastener preferably extends through a plurality of holes formed on both the drive shaft coupler 26 and the tool attachment coupler 28.

A variety of removable tool attachments may be suitable used with the robotic device 10 in accordance with the present invention. In some embodiments, the tool attachment 24 is preferably selected from the group consisting of a lift arm, a swing arm, a claw, a spreader, a ram, a cutter, and an elevator lift.

In a second aspect, the present disclosure also provides a reconfigurable power tool.

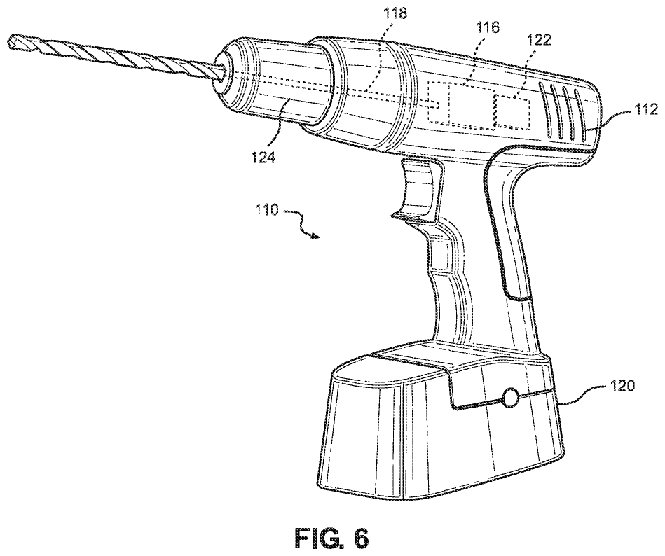

As illustrated in FIG. 6, the power tool 110 includes an exterior frame 112 which provides the general shape of the power tool 110. The frame 112 may for instance provide a pistol grip or other handle for the power tool 110. Additional components of the power tool 110 may be attached to and/or disposed within the frame 112. Similar to the robotic device, the power tool frame 112 may be fabricated any material of suitable strength and weight. Typically, then when lightweight is of greater importance, the frame 112 may preferably be fabricated from a polymeric plastic material. But in other instances where additional strength and/or resistance to harsh environmental conditions is needed, the frame 112 may be fabricated from a metal such as stainless steel.

The power tool 110 also includes a motor 116 which is typically disposed within the power tool frame 112. A rotatable drive shaft 118 is also included which is attached to, and driven, by the motor 116. A tool attachment may then be removably attached to the drive shaft 118 and powered by rotation of the drive shaft 118.

An energy storage device 120 is also for powering the motor 116. Typically, the power tool motor 116 will be an electric motor and the power tool 110 also includes an electrical energy storage device, such as one or more batteries or capacitors, for powering the electric motor. Alternatively, the motor 116 may be an internal combustion engine. In such cases, the power tool 110 will then also include a fuel storage tank in flow communication with the engine. The use of an internal combustion motor may be more preferred for larger power tools.

The power tool 110 also typically includes an electronic control unit 122 for controlling operation of the motor 116.

As noted above, a motor 116 powers the removable tool attachment 124 via the drive shaft 118.

Importantly, according to the present disclosure, the power tool drive shaft 118 and the tool attachment 124 each comprise a coupler having a channel and rib surface, similar to those discussed above, and shown in FIGS. 3 & 4, with respect to the robotic device 10. As with the robotic device 10, the power tool drive shaft 118 includes a coupler 26 having a channel and rib surface 30, and the tool attachment 124 also includes a coupler 28 having a channel and rib surface 32. With these two couplers, the tool attachment 124 may be removable attached to, and later detached from, the drive shaft 118 by slidably interlocking the channel and rib surface of the drive shaft coupler 26 with the channel and rib surface of the tool attachment coupler 28 in a direction substantially perpendicular to the axis of rotation of the drive shaft—rather than in a direction parallel to the axis of rotation of the drive shaft. Thus, a quick and secure alignment between the drive shaft and the tool attachment may be achieved in this manner.

Also, like the robotic device 10, in some embodiments of the present disclosure, the power tool 110 may also include a first alignment guide attached to the power tool frame and a second alignment guide attached to the tool attachment. These first and second alignment guides preferably slidably interlock in a direction substantially perpendicular to the axis of rotation of the drive shaft 118.

As with the robotic device, in some instances, the tool attachment 124 may be sufficiently secured to the drive shaft 118 by just the interlocking of the respective channel and rib surfaces of the drive shaft coupler and of the tool attachment coupler. In other instances, however, a locking mechanism is also used to further secure the tool attachments. The locking mechanism retains the drive shaft coupler and the tool attachment coupler in connection and alignment with one another. In one embodiment, the locking mechanism may for instance be a clamp, while in another embodiment, the locking mechanism may be provided by a retractable sleeve which extends over the drive shaft coupler and the tool attachment coupler. In still another embodiment, a fastener such as a pin or screw may be used to further secure the tool attachment. The fastener preferably extends through a plurality of holes formed both the drive shaft coupler and the tool attachment coupler.

A variety of removable tool attachments may be suitable used in accordance with the present invention. In some embodiments, the tool attachment 124 is preferably selected from the group consisting of a drill, an angle drill, a hammer drive, a rotary hammer, a grinder, a rotary saw, a reciprocating saw, and a torque wrench.

The foregoing description of preferred embodiments for this invention have been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A robotic device comprising:
a robot frame;
a first motor attached to the robot frame and having a rotatable drive shaft attached to, and driven by, the motor;
a tool attachment which is configured to be removably attached to the drive shaft and which is powered by rotation of the drive shaft; and
an electronic control unit for controlling operation of the motor,
wherein the drive shaft and the tool attachment each comprise a coupler having a channel and rib surface and
wherein in the tool attachment is removable attached to the drive shaft by slidably interlocking the channel and rib surface of the drive shaft coupler with the channel and rib surface of the tool coupler in a direction substantially perpendicular to an axis of rotation of the drive shaft.

2. The robotic device of claim 1, wherein the motor is an electric motor and wherein the robotic device further comprises an electrical energy storage device for powering the electric motor.

3. The robotic device of claim 1, wherein the motor in an internal combustion engine and wherein the robotic device further comprises a fuel storage tank in flow communication with the engine.

4. The robotic device of claim 1, wherein the tool attachment is selected from the group consisting of a lift arm, a swing arm, a claw, a spreader, a ram, a cutter, and an elevator lift.

5. The robotic device of claim 1, further comprising a locking mechanism for retaining the drive shaft coupler and the tool attachment coupler in connection and alignment with one another.

6. The robotic device of claim 5, wherein the locking mechanism is selected from the group consisting of a clamp, a sleeve extending over the drive shaft coupler and the tool attachment coupler, and a fastener extending through a plurality of holes formed in the drive shaft coupler and the tool attachment coupler.

7. The robotic device of claim 1, further comprising a first alignment guide attached to the robot body and a second alignment guide attached to the tool attachment, wherein the first and second alignment guide slidably interlock in a direction substantially perpendicular to the axis of rotation of the drive shaft.

8. The robotic device of claim 1, further comprising a plurality of wheels rotatably attached to the robot frame for propelling the frame from a first location to a second location;

9. The robotic device of claim 9, further comprising a second motor for driving the plurality of wheels to propel the robot.

10. The robotic device of claim 1, wherein the control unit includes a radio receiver for receiving control information from an external device.

10. A reconfigurable power tool comprising:
a tool frame;
a motor attached to the tool frame and having a rotatable drive shaft attached to, and driven by, the motor; and
a tool attachment which is configured to be removably attached to the drive shaft and which is powered by rotation of the drive shaft;
wherein the drive shaft and the tool attachment each comprise a coupler having a channel and rib surface and
wherein in the tool attachment is removable attached to the drive shaft by slidably interlocking the channel and rib surface of the drive shaft coupler with the channel and rib surface of the tool attachment coupler in a direction substantially perpendicular to an axis of rotation of the drive shaft.

12. The power tool of claim 10, wherein the motor is an electric motor and wherein the power tool further comprises an electrical energy storage device for powering the electric motor.

13. The power tool of claim 10, wherein the motor in an internal combustion engine and wherein the power tool further comprises a fuel storage tank in flow communication with the engine.

14. The power tool of claim 10, wherein the tool attachment wherein the tool attachment is selected from the group consisting of a drill, an angle drill, a hammer drive, a rotary hammer, a grinder, a rotary saw, a reciprocating saw, and a torque wrench.

15. The power tool of claim 10, further comprising a locking mechanism for retaining the drive shaft coupler and the tool attachment coupler in connection and alignment with one another.

16. The power tool of claim 15, wherein the locking mechanism is selected from the group consisting of a clamp, a sleeve extending over the drive shaft coupler and the tool attachment coupler, and a fastener extending through a plurality of holes formed in the drive shaft coupler and the tool attachment coupler.

17. The power tool of claim 10, further comprising a comprising a first alignment guide attached to the tool frame and a second alignment guide attached to the tool attachment, wherein the first and second alignment guide slidably interlock in a direction substantially perpendicular to the axis of rotation of the drive shaft.
